(19) United States
(12) Patent Application Publication
(10) Pub. No.: US 2012/0235816 A1
(43) Pub. Date: Sep. 20, 2012

(54) ITEM LOCATION AND THEFT PREVENTION SYSTEM

(76) Inventor: Luis Estrada, Oakland, FL (US)

(21) Appl. No.: 13/050,451

(22) Filed: Mar. 17, 2011

(51) Int. Cl. G08B 13/14

(52) U.S. Cl. 340/571

(57) ABSTRACT

An item location and theft prevention system includes a base unit housing having a processor in electrical communication with a memory, a transmitter, a receiver, a communication unit, an input unit and a base power source; the system also includes a property attachment housing having a processor in electrical communication with a memory, a transmitter, a receiver, a communication unit, a switch and a power source.

### BACKGROUND

1. Field of the Invention

The present invention relates generally to locating and protecting personal property, and more particularly to a personal property monitoring system capable of allowing a user to find the location of a monitored device, and automatically notify a user when the monitored device exceeds a predetermined separation distance.

2. Description of the Prior Art

There are a number of theft prevention systems known in the prior art utilizing anti theft devices such as an EAS sensor, for example. Additionally, there are a number of known devices for tracking the movement of items or persons such as RFID tags and GPS locators, for example. Known prior art includes U.S. Pat. No. 4,968,973; U.S. Pat. No. 7,772,982; U.S. Pat. No. 6,577,238 U.S. Publication No. 2003-0008659; and U.S. Publication No. 2010-0156651.

While these devices fulfill their respective objectives, the above identified documents do not disclose an item location and theft prevention system capable of performing the functions described herein.

### SUMMARY OF THE INVENTION

The present invention is directed to an item location and theft prevention system. One embodiment of the present invention can include a base unit having a processor in electrical communication with a memory, a transmitter, a receiver, a communication unit, an input unit and a power source; the system can also include a property attachment unit having a processor in electrical communication with a memory, a transmitter, a receiver, a communication unit, and a power source. When instructed by a user, the base unit can transmit a signal instructing the communication unit of the property attachment unit to activate, in order to locate a lost device.

In another embodiment, both the base unit and the property attachment unit can monitor a separation distance and activate an alarm when the distance exceeds a predetermined threshold.

In yet another embodiment, the property attachment unit can remotely disable an item of value to which it is attached when so instructed by a user, or upon a determination that the predetermined distance threshold has been exceeded.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an item location and theft prevention system that is useful for understanding the inventive concepts disclosed herein.

FIG. 2 is a schematic diagram of the item location and theft prevention system according to one embodiment of the invention.

FIG. 3 is a schematic diagram of the property attachment unit according to an alternate embodiment of the invention.

FIG. 4 is perspective view of an additional embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

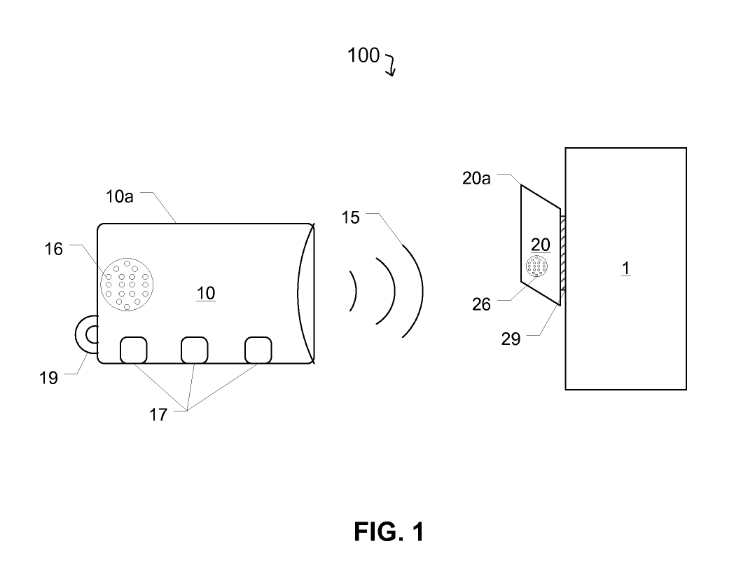

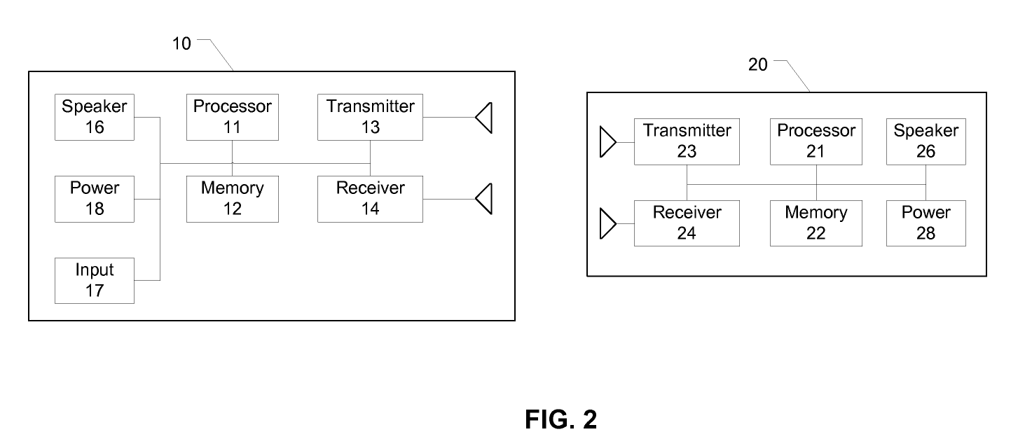

FIGS. 1 and 2 illustrate one embodiment of an item location and theft prevention system 100 that is useful for understanding the inventive concepts disclosed herein. As shown, the system can include a base unit 10 and a property attachment unit (herein PAU) 20 capable of performing two-way communication. In operation, the system 100 can allow a user to remotely activate an audible and/or visual alarm on the PAU 20 in order to determine the location of a device 1 to which the PAU is attached. Additionally, the system 100 can act to automatically trigger an alarm when the distance between the base unit 10 and the PAU 20 exceeds a predetermined threshold.

In one embodiment, the base unit 10, can include an outer shell/body 10a and a processor 11 that is conventionally connected to an internal memory 12, a transmitter 13, a receiver 14, a speaker 16, one or more push buttons 17, a power source 18, and/or an attachment ring 19.

The body 10a can act to securely position each of the elements 11-19 into the base unit 10 in a conventional manner, so as to create a single device. Additionally, the body itself can take any number of distinct shapes, and can be constructed from any number of known materials and methods. In one preferred embodiment, body 10a can be constructed from injection molded plastic having a plurality of connectors (not shown) for securely positioning each of the elements 11-19. Of course, other known materials and manufacturing processes are also contemplated.

The attachment ring 19 can act to secure the base unit 10 to another device. To this end, the attachment unit can preferably include a loop that is integrally formed into the body 10a in order to allow the base unit to be secured to a lanyard or keychain ring. Although described as a ring, other types of securing elements can also be utilized. For example, sheets of hook and loop fasteners (i.e. Velcro®), among other known fasteners, can be applied to the base unit 10 and an external device in a conventional manner. By providing an attachment ring 19 to the base unit 10, a user can easily keep the base unit on their person or in a known location (i.e. attached to a key chain, for example) at all times.

The processor 11 can act to execute program code stored in the memory 12 in order to allow the device to perform the functionality described herein. Processors are extremely well known in the art, therefore no further description will be provided.

Memory 12 can act to store operating instructions in the form of program code for the processor 11 to execute. Although illustrated in FIG. 2 as a single component, memory 12 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 12 can also include one or more cache memories that provide temporary storage of at least some program code in order to reduce the number of times program code must be retrieved from the bulk storage device during execution. Each of these devices are well known in the art.

The transmitter 13 can act to transmit a signal from the base unit 10 to the PAU 20. In one preferred embodiment, the transmitter can include a variable radio wave transmitter having a unique radio frequency chip capable of transmitting a plurality of independent radio frequencies 15, which are stored in the memory 12.

The receiver 14 can act to receive a signal from the PAU 20. In one preferred embodiment, the receiver can include a variable radio wave receiver having a unique radio frequency chip capable of receiving and translating a plurality of independent radio frequencies 15, which can be sent to the processor and/or the memory 12.

Although described above as using radio transmission, reception and frequencies, other communication mediums and their associated components are also contemplated. For example, infrared (IR), Bluetooth, RFID, microwave and other known communication mediums can also be utilized without deviating from the scope and spirit of the inventive concepts disclosed herein.

The speaker 16 can act to notify a user when the location of the PAU 20 has exceeded a specified distance from the base station 10. To this end, the speaker can be connected to the processor 11 in a conventional manner so as to be activated by the processor. Although described as a speaker, one of skill in the art will recognize that virtually any type of notification device, such as one or more light emitting diodes (LED's), for example, can be substituted for, or used in conjunction with the speaker 16, without deviating from the inventive concepts disclosed herein.

A plurality of push buttons 17 can act to accept user inputs and provide instructions to the processor. In one preferred embodiment, each of the buttons can be connected to the processor 11 so as to activate different programmatic functions. Moreover, each button can contain a unique marking M for instructing a user as to the function each button performs.

For example, one push button can act to initiate programming for instructing the processor 12 to immediately activate the speaker 26 on the PAU 20 in order to allow a user to find the location of the PAU. In another example, a second push button can act to turn the system 100 on or off. Although described above as a push button, one of skill in the art will recognize that any number of different input devices ranging from a switch, to a keypad, for example, can also be utilized.

In one preferred embodiment, the power source 18 can include one or more DC batteries capable of providing the necessary power requirements to each element of the base unit 10. In an alternate embodiment (not shown) the power unit can include a common A/C electrical power transformer capable of allowing the base unit 10 to be powered from a standard electrical outlet. Such a feature can be utilized by those users who do not wish for the base unit 10 to be mobile.

The PAU 20, can include a body 20a and a processor 21 that is conventionally connected to an internal memory 22, a transmitter 23, a receiver 24, a speaker 26, a power source 28, and/or an attachment unit 29.

The body 20a can act to securely position each of the elements 21-29 into the PAU in a conventional manner, so as to create a single compact device. Additionally, the body itself can take any number of distinct shapes, and can be constructed from any number of known materials and methods. In one preferred embodiment, body 20a can be constructed from injection molded plastic having a plurality of connectors (not shown) for securely positioning each of the elements 21-28. Of course, other known materials and manufacturing processes are also contemplated. Owing to the fact that the PAU 20 is designed to be secured to items of value 1, it is preferred that the outer body 20a be as small as possible.

The attachment unit 29 can act to secure the PAU 20 to an item of value 1. In one preferred embodiment, attachment unit 29 can include bonded adhesive strips which can be interposed between the body 20a and the item of value 1 so as to create a strong and permanent bond between the items. However, other attachment means ranging from sheets of removable hook and loop strips (i.e. Velcro®), adhesive tape, screws and glue can also be utilized.

The processor 21, memory 22, and speaker 26 can be substantially identical to the elements 11, 12 and 16, respectively, as described above. Moreover, the transmitter 23 and receiver 24 can also include substantially identical components to elements 13 and 14, respectively, in order to receive signals from and transmit signals to the base unit 10.

The power source 28 can act to power each element of the PAU and can preferably include a direct current producing device such as a battery, for example.

In operation, the system 100 can allow a user to quickly and easily identify the location of the PAU 20, and any item 1 to which the PAU is secured, such as a laptop computer, video console, or other valuable object, for example. The process can be initiated by a user selecting an appropriate button 17 from on the base unit 10. Upon detecting that a particular button 17 has been engaged, the processor 11 can signal the transmitter 13 to emit a selected radio frequency 15. This frequency can be received by the receiver 24 of the BAU 20 and decoded by the processor 21 which can activate the BAU speaker 26.

Another operation of the system 100 can include the ability to prevent theft of personal items. To this end, the system 100 can act to monitor a separation distance between the base unit 10 and the PAU 20 and automatically activate the alarm speakers 16 and/or 26 when the distance exceeds a predetermined threshold. In one embodiment, the memory 12 can include programming to allow a user to select from a number of predetermined distances that have been pre-configured within the memory 12. Alternatively, the memory 12 can include programming to allow a user to input a unique desired distance threshold via the input unit 17.

In either case, the memory 12 can include operating instructions for allowing the processor 11 to determine that the distance between the PAU 20 and the base unit 10 exceeds the specified distance threshold. In one preferred embodiment, this determination can be accomplished by measuring the response time of signals sent from the PAU transmitter 23 in response to a transmission received from the base unit 10. For example, the base unit 10 can be programmed to automatically transmit a connection signal to the PAU at specified intervals. Upon receiving the connection signal, the PAU 20 can be programmed to immediately send a response signal. When the response time to receive the response signal from the PAU exceeds a calculated value amount (the value being determined by the specified distance threshold described above), the base unit can determine that the PAU has exceeded the specified distance threshold and can automatically activate the alarm speaker 16 and/or 26.

Moreover, in instances where the PAU does not receive the connection signal at the expected time, the PAU can be programmed to automatically activate the alarm speaker 16 and/or 26 to indicate that the PAU has exceeded the allowable separation distance. In addition to the distance determination scheme described above, one of skill in the art will recognize that any number of known methodologies for determining distance can also be utilized. One such example can include the ability for the base unit 10 and/or the PAU 20 to include programming for determining the signal strength of a received signal.

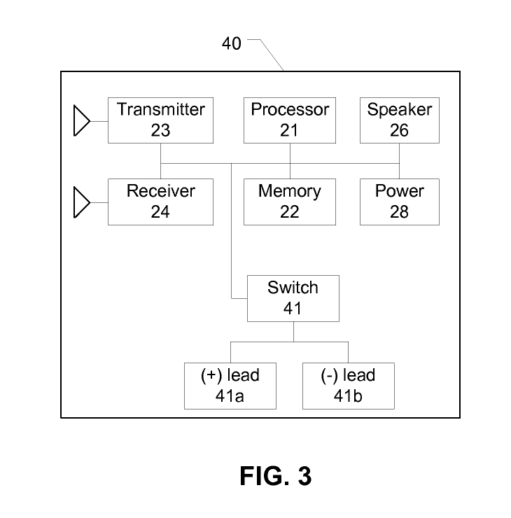

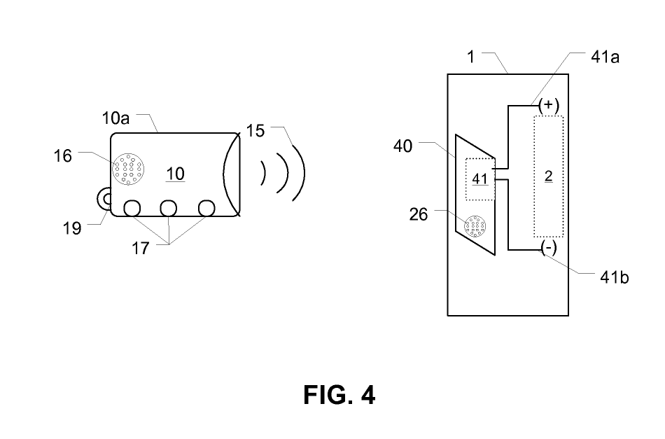

FIGS. 3 and 4 illustrate an alternate embodiment of a system 100 having a PAU 40 that further includes a switch 41 for disabling the power source of the item of value 1 upon a determination that the specified distance threshold has been exceeded.

As shown, the PAU 40 can be connected to the positive and negative terminals of the power source 2 of an item of value 1, via the positive connection lead 41a and the negative connection lead 42b. Upon determining that a separation distance has exceeded the predetermined threshold, the base unit 10 can transmit a kill signal to the PAU 40 which can activate the switch 41 in order to create an open electrical situation, thus temporarily rendering the item of value inoperable. Such a feature can also act to prevent someone from using the item of value 1 outside of the predetermined distance.

Additionally, a user can choose to remotely disable the item of value 1, irregardless of distance location, by selecting an appropriate button 17 (for example, one that contains a marking “disable” or other similar indicator). In this instance, the kill signal can be immediately transmitted from the base station 10 to the PAU 40 in order to disable the device 1.

Although illustrated as an external component for use with existing items of value, other uses are also contemplated. For example, the PAU 20 and PAU 40 can be incorporated into the construction of new items of value as an optional security feature at the time of their manufacture. Such a feature can allow the inventive concepts disclosed herein to be incorporated into the new construction of valuable items in order to allow the end user to easily find, and prevent theft.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An item location and theft prevention system comprising:
a base unit including a housing and a base processor in electrical communication with a base memory, a base transmitter, a base receiver, a base communication unit, a base input unit and a base power source; and
a property attachment unit including a remote housing and a remote processor in electrical communication with a remote memory, a remote transmitter, a remote receiver, a remote communication unit, and a remote power source;
wherein said base transmitter is configured to transmit a unique signal to the property attachment unit, and
said remote receiver is configured to activate the remote communication unit upon receiving the unique signal transmitted by the base unit.

2. The item location and theft prevention system of claim 1, wherein the unique signal includes at least one of a radio signal, an infrared signal, a Bluetooth signal, a microwave signal, and an RFID signal.

3. The item location and theft prevention system of claim 1, wherein each of the base communication unit and the remote communication unit includes at least one of a speaker and a plurality of LED's.

4. The item location and theft prevention system of claim 1, wherein the base unit is configured to be attached to a keychain.

5. The item location and theft prevention system of claim 1, wherein each of the base power source and the remote power source includes at least one direct current (DC) battery.

6. The item location and theft prevention system of claim 1, wherein the base power source includes an AC transformer configured to allow the base unit to be plugged in to a standard electrical outlet.

7. The item location and theft prevention system of claim 1, wherein the property attachment unit is configured to be permanently attached to an inside area of an item of value at the time of construction so as to be an integrated and permanent security feature of the item of value.

8. An item location and theft prevention system comprising:
a base unit including a housing and a base processor in electrical communication with a base memory, a base transmitter, a base receiver, a base communication unit, a base input unit and a base power source; and
a property attachment unit including a remote housing and a remote processor in electrical communication with a remote memory, a remote transmitter, a remote receiver, a remote communication unit, and a remote power source;
wherein said base memory includes programming for instructing the base processor to determine that said property attachment unit is not within a predetermined distance from the base processor, and
said base processor is configured to activate the base communication unit upon determining that the property attachment unit is not within the predetermined distance from the base processor.

9. The system of claim 8, wherein the base memory includes programming for interfacing with the base input unit in order to allow a user to select said predetermined distance.

10. The system of claim 8, wherein said remote memory includes programming for instructing the remote processor to determine that said property attachment unit is not within a predetermined distance from the base processor, and
said remote processor is configured to activate the remote communication unit upon determining that the property attachment unit is not within the predetermined distance from the base processor.

11. An item location and theft prevention system comprising:
a base unit including a housing and a base processor in electrical communication with a base memory, a base transmitter, a base receiver, a base communication unit, a base input unit and a base power source; and
a property attachment unit including a remote housing and a remote processor in electrical communication with a remote memory, a remote transmitter, a remote receiver, a remote communication unit, a remote power source and a remote switch;
wherein said remote switch is configured to disable a power source of an item of value, and
said base unit is configured to transmit a unique frequency to the property attachment unit, and said property attachment unit is configured to activate the remote switch upon receiving the unique frequency transmitted by the base unit.

12. The item location and theft prevention system of claim 11, wherein the base unit is configured to transmit the unique frequency in response to an input from a user.

13. The item location and theft prevention system of claim 11, wherein said base memory includes programming for instructing the base processor to determine that said property attachment unit is not within a predetermined distance from the base processor, and upon determining that the property attachment unit is not within the predetermined distance, the base processor is configured to instruct the base processor to transmit the unique frequency to the property attachment unit to activate the remote switch.

14. The item location and theft prevention system of claim 11, wherein said remote memory includes programming for instructing the remote processor to determine that said property attachment unit is not within a predetermined distance from the base processor, and upon determining that the property attachment unit is not within the predetermined distance, the remote processor is configured to activate the remote switch.
